(19) United States
(12) Patent Application Publication
(10) Pub. No.: US 2007/0186718 A1
(43) Pub. Date: Aug. 16, 2007

(54) Bicycle cranks composed of composite material and metal parts and method for making the same

(76) Inventor: Douglas Chiang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/352,242

(22) Filed: Feb. 13, 2006

(51) Int. Cl. B29C 70/34; G05G 1/14

(52) U.S. Cl. 74/594.1; 264/257; 264/314

(57) ABSTRACT

A bicycle crank includes a hollow body made by composite material and two metal connection members are connected on two ends of the hollow body. A mold includes an elongate cavity and two metal connection members are put in the cavity. Composite material arranged as a loop is put in the elongate cavity and the two metal connection members are enclosed within the loop of the composite material. Two inflatable bladders are put in the elongate cavity and each bladder has a closed end and an open end. The two bladders are arranged along two long sides of the elongate cavity. The two inflatable bladders are inflated by introducing high temperature air from the open ends and push the loop of the composite material to contact against the inside of the elongate cavity and the composite material is solidified and combined with the metal connection members.

### FIELD OF THE INVENTION

The present invention relates to a method for making bicycle cranks which are made by composite material and two metal connection members are pre-set in the molds of the cranks.

### BACKGROUND OF THE INVENTION

Conventional bicycle cranks generally are made by metal and require specific structural strength. One end of the crank is connected with the bottom bracket and the other end of the crank is connected with a pedal, the users tread the pedals to drive the bicycle move forward via a transmission system including sprockets, gears and a chain. It is noted that metal-made cranks are too heavy and costly so that some manufactures use composite material such as carbon fibers to make the cranks with light in weight. However, the composite material and the metal parts cannot be combined within one manufacturing process so that the manufacturers usually insert the metal parts to the solidified composite material when the cranks are formed, and adhesive is used to secure the metal parts to the composite material. The connection between the metal parts and the composite material is not strong enough and includes potential safety risks. Besides, it requires extra time and labor cost to finish the connection.

The present invention intends to provide bicycle cranks and a method for making the cranks wherein the metal parts and the composite material are combined with each other within one manufacturing process.

### SUMMARY OF THE INVENTION

The present invention relates to a bicycle crank which includes a hollow body made by composite material and two metal connection members are connected on two ends of the hollow body.

The crank of the present invention is made by using a mold including an elongate cavity and two metal connection members are put in the cavity. Composite material arranged as a loop is put in the elongate cavity and the two metal connection members are enclosed within the loop of the composite material. Two inflatable bladders are put in the elongate cavity and each bladder has a closed end and an open end. The two bladders are arranged along two long sides of the elongate cavity. The two inflatable bladders are inflated by introducing high temperature air from the open ends and push the loop of the composite material to contact against the inside of the elongate cavity. The composite material is solidified and combined with the metal connection members.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the composite material, the two metal connection members and two inflatable bladders are put in the concavity of the mold;

FIG. 2 is a side cross sectional view to show the crank of the present invention;

FIG. 3 is an end cross sectional view to show the crank of the present invention, and

FIG. 4 is a perspective view of the crank of the present invention, wherein a section of the crank is removed.

### DETAILED DESCRIPTION OF THE PREFERRED EMBODIMENT

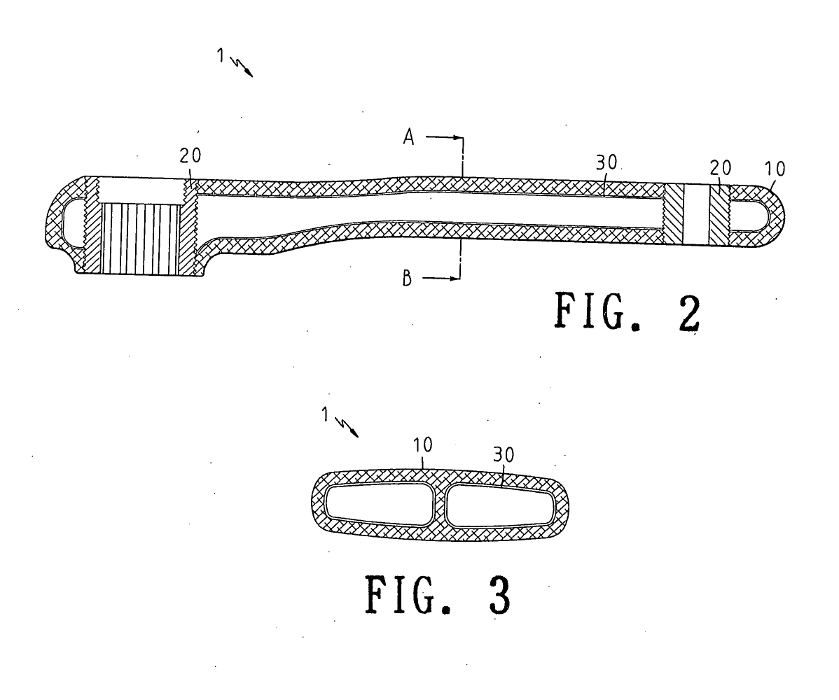

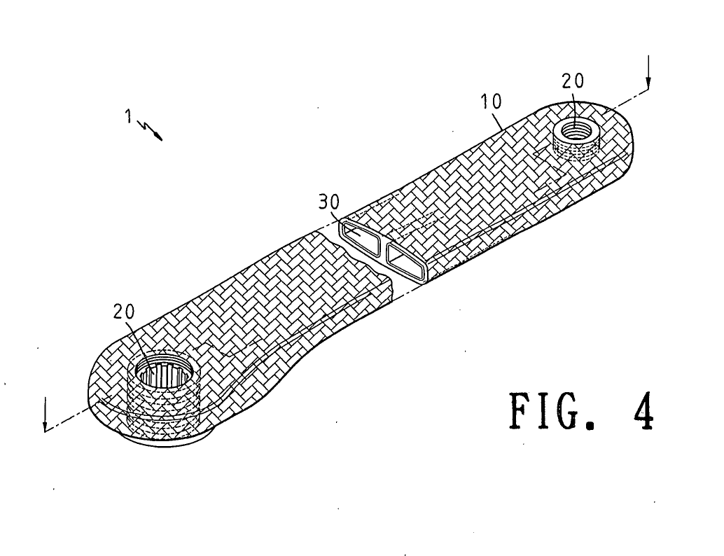

Referring to FIG. 2 to 4, the bicycle crank 1 of the present invention comprises a hollow body 10 made by composite material and two metal connection members 20 are connected on two ends of the hollow body 10. The composite material is carbon fiber and epoxide resin.

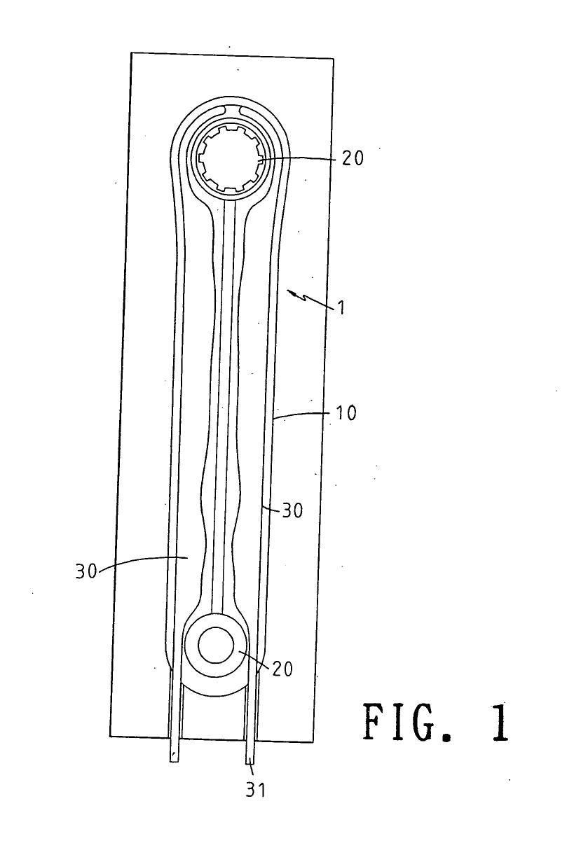

Referring to FIG. 1, the bicycle crank of the present invention is made by the following steps:

step 1: preparing a mold with an elongate cavity defined therein and the two metal connection members 20 being put in the cavity, the elongate cavity including an enclosed inside;

step 2: arranging the composite material as a loop and putting the loop of the composite material in the elongate cavity along the inside of the elongate cavity, the two metal connection members 20 being enclosed within the loop of the composite material;

step 3: inserting two inflatable bladders 30 in the elongate cavity and each bladder 30 having a closed end and an open end 31 which extends through the loop of the composite material, the two bladders 30 being arranged along two long sides of the elongate cavity;

step 4: inflating the two inflatable bladders 30 by introducing high temperature air from the open ends to inflate the bladders 30 which push the loop of the composite material to contact against the inside of the elongate cavity, the loop of the composite material being solidified by the high temperature and the two metal connection members 20 being combined with the composite material;

step 5: removing the crank made by solidified composite material and metal connection members 20 from the mold, and step 6: sealing the open ends.

The method allows the cranks to have desired shapes and the cranks have a hollow body 10 so that they are light in weight. The method also saves the process of gluing the metal connection members 20 to the composite material as described in the conventional method.

While we have shown and described the embodiment in accordance with the present invention, it should be clear to those skilled in the art that further embodiments may be made without departing from the scope of the present invention.

What is claimed is:

1. A bicycle crank comprising:
a hollow body made by composite material and two metal connection members which are connected on two ends of the hollow body.

2. The bicycle crank as claimed in claim 1, wherein the composite material is carbon fiber and resin.

3. The bicycle crank as claimed in claim 2, wherein the resin is epoxide resin.

4. A method for making bicycle cranks, comprising:
step 1: preparing a mold with an elongate cavity defined therein and two metal connection members being put in the cavity, the elongate cavity including an enclosed inside;
step 2: arranging composite material as a loop and putting the loop of the composite material in the elongate cavity along the inside of the elongate cavity, the two metal connection members being enclosed within the loop of the composite material;
step 3: inserting two inflatable bladders in the elongate cavity and each bladder having a closed end and an open end which extends through the loop of the composite material, the two bladders being arranged along two long sides of the elongate cavity;
step 4: inflating the two inflatable bladders by high temperature air to inflate the bladders which push the loop of the composite material to contact against the inside of the elongate cavity, the loop of the composite material being solidified by the high temperature and the two metal connection members being combined with the composite material, and
step 5: removing the crank made by solidified composite material and metal connection members from the mold.
